(19) United States
(12) Patent Application Publication
(10) Pub. No.: US 2022/0312810 A1
(43) Pub. Date: Oct. 6, 2022

(54) SYSTEM AND METHODS FOR MAKING A JACKFRUIT PRODUCT

(71) Applicant: Bali Grove Pte Ltd, Singapore (SG)

(72) Inventors: Daniel Maximilian Riegler, Westport, CT (US); Blair Daniel Scott Crichton, HongKong (CN); Carsten Carstens, Hamburg (DE)

(73) Assignee: Bali Grove Pte Ltd, Singapore (SG)

(21) Appl. No.: 17/707,983

(22) Filed: Mar. 30, 2022

Related U.S. Application Data
(60) Provisional application No. 63/168,094, filed on Mar. 30, 2021.

(51) Int. Cl. A23L 19/00; A23L 3/36; B65B 25/04

(52) U.S. Cl. CPC A23L 19/03; A23L 3/36; A23L 19/09; B65B 25/041; A23V 2002/00

(57) ABSTRACT

A method to create a shredded jackfruit product is described and includes: pre-heating a mixer or tumbler; adding dried shredded jackfruit to the mixer or tumbler; adding a hot brine to the mixer or tumbler; sealing the mixer or tumbler; placing the mixer or tumbler in a vacuum; and tumbling the tumbler at a rate for a time period until the hot brine is absorbed in the dried shredded jackfruit to form a final shredded jackfruit product. A method to create a minced product from shredded jackfruit is also described and includes: chilling shredded jackfruit to a temperature; transferring the chilled shredded jackfruit to a grinder; grinding the chilled shredded jackfruit; preparing a binding agent emulsion using a device; and preparing a minced product.

### CROSS-REFERENCE TO RELATED APPLICATIONS SECTION

This application is a U.S. Non-Provisional Patent Application that claims priority to U.S. Provisional Patent Application Ser. No. 63/168,094 filed on Mar. 30, 2021, the entire contents of which are hereby incorporated by reference in their entirety.

### FIELD OF THE EMBODIMENTS

The field of the invention and its embodiments relate to a system and method for making a jackfruit product.

### BACKGROUND OF THE EMBODIMENTS

The jackfruit (Artocarpus heterophyllus) (“the jack tree”) is a species of tree in the fig, mulberry, and breadfruit family (Moraceae), finding its origin in the region between the Western Ghats of southern India and the rainforests of Malaysia. The jack tree is well-suited to tropical lowlands, and is widely cultivated throughout tropical regions of the world. It bears the largest fruit of all trees, reaching as much as 55 kg (120 pounds) in weight, 90 cm (35 inches) in length, and 50 cm (20 inches) in diameter. A mature jack tree produces some 200 fruits per year, with older trees bearing up to 500 fruits in a year.

Jackfruit is higher in some vitamins (e.g., vitamin B and vitamin C) and minerals than apples, apricots, bananas, and avocados. Moreover, as a jackfruit ripens, its carotenoid levels rise, which helps serve to protect cells from damage. Jackfruit also contains many other antioxidants that can help delay or prevent cell damage in one's body. These benefits make jackfruit favorable for consumption, especially for health-conscious consumers.

Jackfruit is currently a trendy new food used by many to create meatless products. However, the consistency of young/unripe jackfruit is entirely different from the consistency of ripe jackfruit. Typically, a jackfruit weighs between 30 and 50 pounds. Further, the skin of the jackfruit is often difficult to cut through to get to the creamy white interior, which is filled with fibrous fruit and large pits. Thus, not only is jackfruit difficult to obtain, as most grocery stores carry it as a canned or pouched item, but the preparation and cooking of jackfruit is often complicated and time-consuming. As such, there is a need for an improved method for making a jackfruit product.

### REVIEW OF RELATED TECHNOLOGY

IN202041034568A describes jackfruit based vegan food products.
GB2558130B and US20190037893A1 describe meat-like food products having structures, textures, and other properties comparable to those of animal meat. Some of these meat-like food products contain jackfruit.
BR102018068336A2 describes use of dehydrated jackfruit used as a food source.
PH22018000750U1 describes a meat tenderizer composition that includes powdered dried jackfruit.
WO2017064733A4, US20180303138A1, and IN201847013577A describe jackfruit flour prepared from various parts of the jackfruit that can be used as an additive or a substitute for human consumption.
PH22017000174U1 describes a method for preparing a burger patty with jackfruit seed flour.
CN103179867B describes a method of producing dehydrated food products having light color with less browning, when compared with the same food products. Portions of the invention relate to dehydrated apples, bananas, figs, grapes, pineapples, jackfruits, etc.

Various methods for making a jackfruit product exist. However, their means of operation are substantially different from the present disclosure, as the other inventions fail to solve all the problems taught by the present disclosure.

### SUMMARY OF THE EMBODIMENTS

The present invention and its embodiments relate to a system and method for making a jackfruit product.

A first embodiment of the present invention describes a method to create a shredded jackfruit product. The method includes numerous process steps, such as: pre-heating a mixer or tumbler and adding dried shredded jackfruit and a hot brine to the mixer or tumbler. The brine may be created by mixing water, an oil component, and a flavoring component at a high speed for a time period of approximately 3 to 5 minutes to achieve a homogenous consistency. Moreover, a ratio of the dried shredded jackfruit to the hot brine in the tumbler or the mixer may range from 1:3 to 1:6. In preferred examples, the hot brine includes approximately 90-98% water, approximately 1-10% of an oil and approximately 0.5-5.0% of a flavoring agent. The oil may be a canola oil, a soybean oil, a corn oil, a grapeseed oil, or any other vegetable oil. The temperature of the hot brine may range from approximately 75° C. to 95° C.

Next, the method includes sealing the tumbler or the mixer and placing the mixer or tumbler in a vacuum. The vacuum is preferably a 70-90% vacuum having a moisture filter to absorb evaporated liquid. Next, the mixer or the tumbler is tilted and tumbled at a rate of approximately 6 rpm for approximately 15-30 minutes until the hot brine is absorbed in the dried shredded jackfruit to form a final shredded jackfruit product. Optionally, the method further includes: packaging the final shredded jackfruit product.

A second embodiment of the present invention describes a method to create a minced product from shredded jackfruit (formed by the first embodiment). The method includes numerous process steps, such as: chilling the shredded jackfruit, transferring the chilled shredded jackfruit to a grinder, grinding the chilled shredded jackfruit, and preparing a binding agent emulsion using a device. The binding agent may be a cellulose or a modified cellulose, namely a hydroxypropylmethylcellulose or methylcellulose, or a blend of the above. In preferred examples, the device may be a bowl chopper with a vacuum.

Moreover, preparation of the binding agent emulsion using the device comprises the following process steps: adding approximately 1-10% of a vegetable oil and approximately 3-5% of a binding agent to the device, mixing the vegetable oil and the binding agent to obtain a slurry, and adding approximately 85-95% ice to the device. The vegetable oil may be a canola oil, a soybean oil, a corn oil, a grapeseed oil or any other vegetable oil with a comparable viscosity or a mixture of the above to the device. Further, the preparation of the binding agent emulsion using the device also includes: setting the device to a maximum vacuum and chopping components within the device at a maximum chopping speed to form the binding agent emulsion until a second temperature in a range of approximately 5° C. to 8° C. is reached.

The method further includes: preparing a minced product. Such preparation includes the following process steps: adding approximately 60-80% of a chilled ground shredded jackfruit product, approximately 0.1-1% of a flavoring agent or component, and approximately 0.1-1% of a salt to the binding agent emulsion (e.g., present in an amount of approximately 25-35%) in the device, mixing components present in the device until a homogenous product is formed, adding approximately 1-10% of a vegetable oil to the device, and mixing the components in the device until the minced product is formed. The vegetable oil may be a canola oil, a soybean oil, a corn oil, a grapeseed oil or any other vegetable oil with a comparable viscosity or a mixture of the above to the device. The method may optionally include transferring the minced product to a packaging line for packing and freezing.

### BRIEF DESCRIPTION OF THE DRAWINGS

FIG. 1 depicts a block diagram of a method to create a shredded jackfruit product, according to at least some embodiments disclosed herein.

FIG. 2 depicts a block diagram of a method utilizing the final shredded jackfruit product of FIG. 1 to create a minced product, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

### Jackfruit

Artocarpus heterophyllus Lam, commonly known as the jackfruit tree and belonging to the family Moraceae, is an exotic tree originally native to the Western Ghats of India. The fruits are of dietary use and are an important source of carbohydrate, protein, fat, minerals and vitamins. Researchers have found that the bark, roots, leaves, and fruit have numerous medicinal properties. Preclinical studies have shown that jackfruit possesses antioxidant, anti-inflammatory, antibacterial, anticariogenic, antifungal, antineoplastic, hypoglycemic, and wound healing effects. See, Manjeshwar Shrinath Balig, et al., “Phytochemistry, Nutritional and Pharmacological Properties of Artocarpus Heterophyllus Lam (Jackfruit): A Review,” Food Research International, 2011, Vol. 44, Issue 7, Pages 1800-1811, the entire contents of which are hereby incorporated by reference in their entirety.

Moreover, others have found that the jackfruit provides about 2 MJ of energy per kg/wet weight of ripe perianth (e.g., the non-reproductive part of the flower). See, Shrikant Baslingappa Swami, et al., “Jackfruit and its Many Functional Components as Related to Human Health: A Review,” Comprehensive Reviews in Food Science and Food Safety, 2012, Vol. 11, Issue 6, Pages 565-576, the entire contents of which are hereby incorporated by reference in their entirety. Further, jackfruit has been reported to contain high levels of protein, starch, calcium, and thiamine. See, H. M. Burkill, et al., “The Useful Plants of West Tropical Africa,” Vol. 4, 2nd Ed. Royal Botanic Gardens: Kew, U.K. p 160-161, the entire contents of which are hereby incorporated by reference in their entirety.

Other researchers have extracted starch from the jackfruit seeds and characterized to chemical, morphological and functional properties. Soft and hard jackfruit seeds showed starch content of 92.8% and 94.5%, respectively. Starch granules showed round and bell shape and some irregular cuts on their surface with type-A crystallinity pattern, similar to cereals starches. These results suggest that the Brazilian jackfruit seeds starches could be used in food products. See, Marta Suely Madruga, et al., “Chemical, Morphological and Functional Properties of Brazilian Jackfruit (Artocarpus heterophyllus L.) Seeds Starch,” Food Chemistry, 2014, Vol. 143, Pages 440-445, the entire contents of which are hereby incorporated by reference in their entirety. Moreover, other researchers have isolated sustainable nanomaterials, cellulose, and spherical cellulose nanocrystals (SCNCs) from the non-edible parts of jackfruit (Artocarpus heterophyllus). See, C. Trilokesh, et al., “Isolation and Characterization of Cellulose Nanocrystals From Jackfruit Peel,” Scientific Reports, 2019, Vol. 9, Article No. 16709, the entire contents of which are hereby incorporated by reference in their entirety.

Due to all of these aforementioned reasons, jackfruit is commonly used in South and Southeast Asian cuisines, where both ripe and unripe fruits are consumed. The seeds may be boiled or roasted and eaten or boiled and preserved in syrup, like chestnuts. Roasted, dried seeds are ground to make flour that is blended with wheat flour for baking. See, Shrikant Baslingappa Swami, et al., “Jackfruit and its Many Functional Components as Related to Human Health. A Review,” Comprehensive Reviews in Food Science and Food Safety, 2012, Vol. 11, Issue 6, Pages 565-576; F. O. Bobbio, et al., “Isolation and Characterization of the Physicochemical Properties of the Starch of Jackfruit Seeds (Artocarpus heterorphyllus),” Cereal Chem., 1978, Vol. 55, Pages 505-511; and Y. Selvaraj, et al., “Biochemical Changes During Ripening of Jackfruit (Arlocarpus heterophyllus L),” 1989, J Food Sci Technol, Vol. 26, Pages 304-307, the entire contents of which are hereby incorporated by reference in their entirety.

Others have suggested the use of jackfruit in meatless products. See, Navela Rahma Aji, et al., “Meat Analog Based Necklace Crickets and Fruit (Jackfruit And Pumpkin) as an Alternative Source of Animal Protein Ingredients Food in Gunung Kidul,” Journal of Scientific and Innovative Research, 2016, Vol. 5, Issue 5, Pages 179-181; M. A. Hamid, et al., “The Application of Jackfruit By-Product on the Development of Healthy Meat Analogue,” 2020, IOP Conf. Ser.: Earth Environ. Sci., 575, 012001; and Iman Abdullah, “Effect of Using Unripe Jackfruit As A Meat Substitute On Nutrition Composition And Organoleptic Characteristic Of Meat Patty,” 2017, Politeknik & Kolej Komuniti Journal of Engineering and Technology, Vol. 2, No. 1, Pages 96-106, the entire contents of which are hereby incorporated by reference in their entirety. However, there is often difficulty in preparing and cooking jackfruit for such meatless products.

### Method

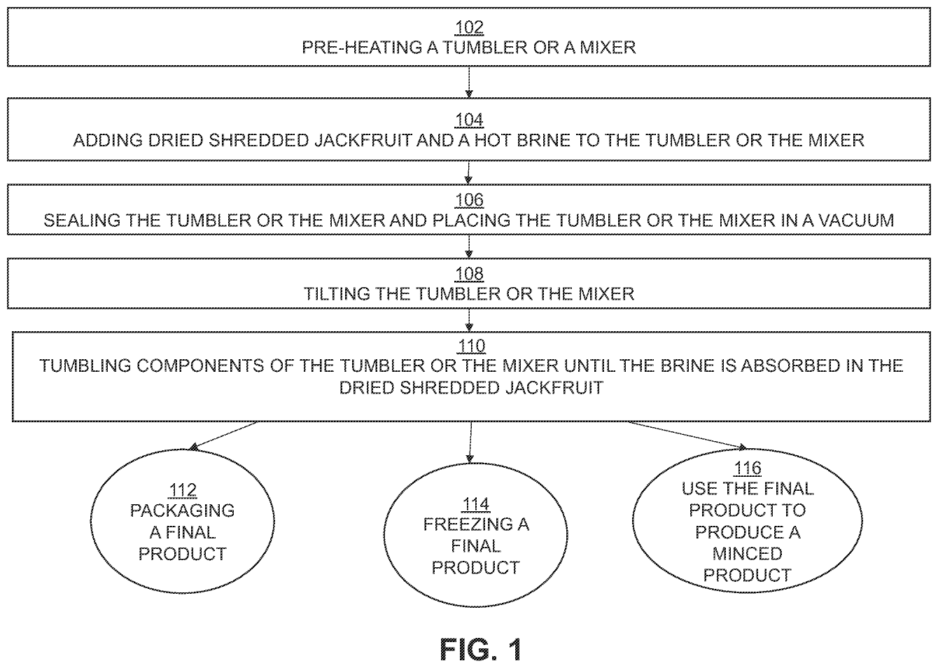

FIG. 1 depicts a block diagram of a method to create a shredded jackfruit product, according to at least some embodiments disclosed herein. FIG. 1 includes numerous process steps. The method of FIG. 1 begins at a process step 102, that includes pre-heating a tumbler or a mixer. In some examples, the tumbler may be a vacuum tumbler with water. A process step 104 follows the process step 102 and includes adding dried shredded jackfruit and a hot brine to the tumbler. It should be appreciated that the dried shredded jackfruit is added into the pre-heated tumbler prior to the addition of the hot brine. The brine comprises water, an oil component, and a flavoring component. In examples, the water comprises hot water (at approximately 75-95° C.) and the oil component comprises a vegetable oil. The vegetable oil may be a canola oil, a soybean oil, a corn oil, a grapeseed oil or any other vegetable oil with a comparable viscosity or a mixture of the above. In specific examples, the brine comprises approximately 90-98% of water, approximately 1-10% of the vegetable oil, and approximately 0.5-5% of the flavoring agent or component. The brine is kept hot until the dried shredded jackfruit is added to the tumbler or the mixer.

The process step 106 follows the process step 104 and includes sealing the tumbler or the mixer and placing the tumbler or the mixer in a vacuum. It should be appreciated that to accommodate the specific aspects of the invention described herein, special moisture filters are installed with the vacuum tumbler to absorb evaporated liquid and prevent vacuum pump corrosion for steam condensate. Holding hot liquids under vacuum increases evaporation and could cause damage to vacuum pump due to a built-up of evaporated water in the pump's oil. In some examples, the vacuum may be used since the instant invention only partially rehydrates the jackfruit to ensure that the final product is meaty and fibrous. To ensure even moisture distribution throughout the final product and to achieve uniform texture at this hydration rate, mixing has to be performed under vacuum, as it increases moisture distribution.

Then, a process step 108 follows the process step 106 and includes tilting the tumbler or the mixer. A process step 110 follows the process step 108 and includes tumbling components of the tumbler or the mixer at a rate of approximately 6 rpm and mixing for approximately 15-30 minutes to ensure that the brine is fully absorbed in the shredded jackfruit product. The temperature of the shredded jackfruit should be above approximately 70° C. to 80° C. once the tumbling stage is completed to ensure microbial safety of the final shredded jackfruit product. It should be appreciated that the brine should be fully absorbed in the shredded jackfruit to ensure that the final product has a proper amount of meaty fibers. If underdone, jackfruit shreds will still be hard. If overdone, the jackfruit shreds will be soft and mushy.

This “hot-soak” method allows the shredded jackfruit to simultaneously be soaking in the brine and cooking. Without exposure to heat, the dried jackfruit shreds will not sufficiently absorb all of the brine and hence will not yield the meat-like texture specific to the invention described herein.

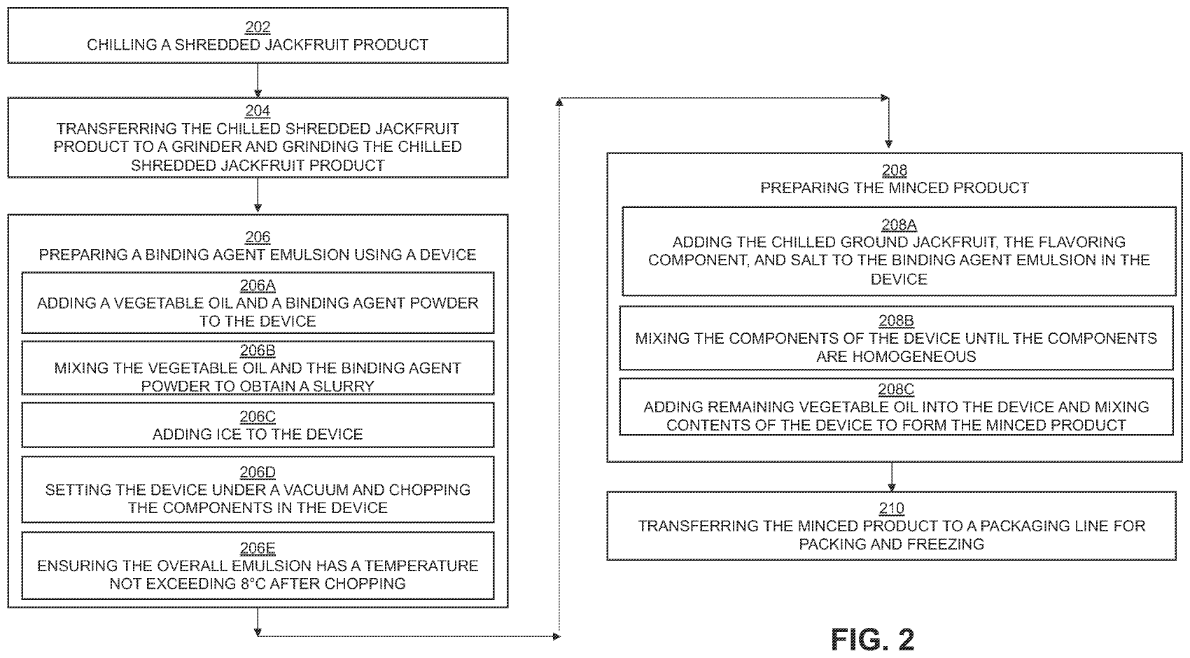

Next, a process step 112, a process step 114, or a process step 116 follows the process step 110. The process step 112 includes packaging the shredded jackfruit. The process step 114 packaging chilled shredded jackfruit. The process step 116 includes utilizing the final product to create a minced product. The process steps for the minced production described in the process step 116 are described in FIG. 2 herein.

Specifically, the process step 114 includes transferring the shredded jackfruit to a chilled room/refrigeration unit below approximately 4° C. and packaging the shredded jackfruit. For packaging, the shredded jackfruit may be filled into pouches. The pouches may then be sealed under partial vacuum. The packages are then taken and stored immediately in a blast freezer. Once frozen, the packages are packed in boxes, stored in freezers, and are ready for shipping/delivery to customers.

In some examples, alternative protocols/steps may be used in FIG. 1. In a first alternative example, open tray cooking may be used, whereby the dried jackfruit and an ambient temperature brine are mixed, allowing the brine to soak into the dried jackfruit for approximately 1-3 hours. Next, the dried jackfruit and the brine components are placed on trays, covered, steamed at approximately 100° C. for approximately 1-3 hours.

In a second alternative example, the dried jackfruit and the ambient temperature brine are placed in sous-vide pouches, vacuumed, and sealed. The pouches are then placed in an agitated approximately 70° C. to 90° C. water bath and kept for approximately 2-5 hours until a core temperature of approximately 75° C. to 85° C. is reached. An advantage of this sous-vide method is that it simultaneously provides a pasteurisation of the product held inside the pouches so that the product can potentially be kept for prolonged time periods.

In a third alternative example, the dried jackfruit and the ambient temperature brine are placed in retort pouches, vacuumed, and sealed. The pouches are then placed in a retort machine and kept until a sterilizing value or an F(0) value of minimum 2 is reached. It should be appreciated that, as described herein, the “sterilizing value” describes the level of microbial destruction obtained by thermal treatment. The results are expressed in minutes or, to be more precise, in equivalent-minutes of exposure to approximately 121.1° C.

Differing from other processes/methods known in the field, the method of FIG. 1 utilizes dried jackfruit shreds, as compared to fresh jackfruit, which results in dramatically different textures for the final product. For example, the final product of FIG. 1 is meatier and less mushy than products that begin with fresh jackfruit.

In further alternative examples, the mixer or the tumbler described herein is equipped with active heating (steam injection) and active cooling (liquid nitrogen injection) systems. This customized modification allows for the aforementioned production process (e.g., production of the jackfruit shreds, production of the binding agent emulsion, mixing of the mince, etc.) to be carried out and directly managed. Such direct management allows for direct control over the temperature, and thus, key quality parameters (e.g., texture, microbial safety, etc.) of the final product.

In this process, the components for preparation of the brine are brought together in the mixer or the tumbler and brought up to a temperature of approximately 75° C. to 95° C. through steam injection. Then, dried jackfruit is added and a vacuum is applied. The product is mixed and simultaneously cooked, with continuous steam injection allowing for the maintenance of temperatures in a range of approximately 80° C. to 85° C. After approximately 15-30 minutes of mixing, the temperature of the product is reduced to approximately 4° C. through injection of liquid nitrogen. This process allows for the target texture of the final product to be reached in a shorter time span, while allowing for a reduction in the microbial load.

FIG. 2 depicts a block diagram of a method utilizing the final shredded jackfruit product of FIG. 1 to create a minced product, according to at least some embodiments disclosed herein. The method of FIG. 2 begins at a process step 202, where the final shredded jackfruit product of FIG. 1 is chilled. A process step 204 follows the process step 202 and includes transferring the chilled shredded jackfruit product of the process step 202 to a grinder and grinding the shredded jackfruit product. A process step 206 follows the process step 204 and includes preparing a binding agent emulsion using a device. As defined herein, the binding agent may be a cellulose or a modified cellulose, namely a hydroxypropylmethylcellulose or methylcellulose, or a blend of the above In examples, the device is a bowl chopper with a vacuum.

The process step 206 comprises a process step 206A-a process step 206E. The process step 206A includes: adding approximately 1-10% of a vegetable oil and approximately 3-5% of the binding agent to the device (such as a bowl chopper). The vegetable oil may be a canola oil, a soybean oil, a corn oil, a grapeseed oil or any other vegetable oil with a comparable viscosity or a mixture of the above. Then, a process step 206B occurs and includes mixing the vegetable oil and the binding agent to obtain a slurry. The binding agent needs to be evenly dispersed and mixed in the vegetable oil to prevent the formation of lumps when the slurry comes into contact with water. Then, a process step 206C occurs and includes adding approximately 85-95% ice to the device. The ice is used at the process step 206C to ensure full solubility and activation of the binding agent.

Next, a process step 206D occurs, where the device is set to a maximum vacuum and components within the device are chopped at a maximum chopping speed (e.g., 2000-6000 rpm) to form the binding agent emulsion until a second temperature in a range of approximately 5° C. to 8° C. is reached. Prior to proceeding, a visual inspection is done to ensure that no pockets of unmixed slurry remain in the device. The result of the process step 206D includes formation of the binding agent emulsion. The chopping of this step continues until the binding agent emulsion reaches a temperature in a range of approximately 5° C. to 8° C. A process step 206E follows the process step 206D and includes ensuring that the overall binding agent emulsion has a temperature not exceeding approximately 8° C. after chopping.

Then, a process step 208 follows the process step 206E and includes preparing the minced product 702. It should be appreciated that the process step 208 comprises a process step 208A-a process step 208C. The process step 208A includes adding approximately 60-80% of a chilled ground shredded jackfruit product, approximately 0.1-1% of a flavoring agent or component, and approximately 0.1-1% of a salt to the binding agent emulsion (e.g., present in an amount of approximately 25-35%) in the device.

A process step 208B follows the process step 208A and includes mixing the components of the device until the components are homogenous. A process step 208C follows the process step 208B and includes: adding approximately 1-10% of a vegetable oil to the device and mixing contents of the device to form the minced product. The vegetable oil may be a canola oil, a soybean oil, a corn oil, a grapeseed oil or any other vegetable oil with a comparable viscosity or a mixture of the above to the device. Addition of vegetable oil in this stage gives the final product a shiny and fatty appearance and increases the mouthfeel of the final product. In this process step, the vegetable oil is not fully emulsified, as opposed to the vegetable oil used in the production of the binding agent emulsion, and hence forms a thin coating layer on top of the final product. It should be appreciated that other components may be added at this process step to modify the texture and/or mouthfeel of the final product, such as, but not limited to: small particles of hardened fats, emulsified oils, and/or hydrocolloids, etc. A process step 210 follows the process step 208C and includes: transferring the minced product to a packaging line for packaging and freezing.

It should be appreciated that the equipment used in the process steps of FIG. 2 may be replaced with other equipment. For example, the device may be a mixer, which may be equipped with active heating (steam injection) and active cooling (liquid nitrogen injection) systems. This customized modification allows the production processes (e.g., production of the jackfruit shreds, production of the binding agent emulsion, mixing of the mince, etc.) to be directly managed. Such direct management allows for the control of the temperature during the process steps, allowing for the binding agent to be dispersed in ambient temperature water in the mixer and, through the injection of liquid nitrogen, the temperature is slowly brought down to facilitate incremental dissolving of the binding agent and thus gradual increase in viscosity without lump formation. The ground jackfruit and additional ingredients may then be added to this gel and mixed until homogeneous.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method to create a shredded jackfruit product, the method comprising:
pre-heating a mixer or tumbler;
adding dried shredded jackfruit to the mixer or tumbler;
adding a hot brine to the mixer or tumbler;
sealing the mixer or tumbler;
placing the mixer or tumbler in a vacuum; and
tumbling the tumbler at a rate for a time period until the hot brine is absorbed in the dried shredded jackfruit to form a final shredded jackfruit product.

2. The method of claim 1, wherein the hot brine comprises water, an oil component, and a flavoring component.

3. The method of claim 2, wherein water is present in an amount of approximately 90-98% of the hot brine.

4. The method of claim 2,
wherein the oil component comprises a vegetable oil present in an amount of approximately 1-10% of the hot brine, and
wherein the oil component is selected from the group consisting of: a canola oil, a soybean oil, a corn oil, and a grapeseed oil.

5. The method of claim 2, wherein the flavoring component comprises a flavoring agent powder present in an amount of approximately 0.5-5.0% in the hot brine.

6. The method of claim 1, wherein the hot brine has a temperature between approximately 75° C. to 95° C.

7. The method of claim 1, wherein a ratio of the dried shredded jackfruit to the hot brine in the mixer or the tumbler is approximately 1:3-1:6.

8. The method of claim 1, wherein the vacuum comprises a 70-90% vacuum having a special moisture filter to absorb evaporated liquid.

9. The method of claim 1,
wherein the rate is approximately 6 rpm, and
wherein the time period is approximately 15-30 minutes.

10. The method of claim 1, further comprising:
transferring the final shredded jackfruit product to a chilled room below a temperature; and
packaging the final shredded jackfruit product.

11. The method of claim 1, further comprising:
filling the final shredded jackfruit product into pouches;
sealing the pouches under partial vacuum conditions; and
storing the pouches in a freezer.

12. A method to create a minced product from shredded jackfruit, the method comprising:
chilling shredded jackfruit to a temperature;
transferring the chilled shredded jackfruit to a grinder;
grinding the chilled shredded jackfruit;
preparing a binding agent emulsion using a device; and
preparing a minced product.

13. The method of claim 12, wherein the device comprises a bowl chopper with a vacuum.

14. The method of claim 12, wherein the preparing of the binding agent emulsion using the device comprises:
adding a vegetable oil to the device;
adding a binding agent to the device;
mixing the vegetable oil and the binding agent to obtain a slurry; and
adding ice to the slurry in the device.

15. The method of claim 14, wherein the vegetable oil is selected from the group consisting of: a canola oil, a soybean oil, a corn oil, and a grapeseed oil.

16. The method of claim 14, wherein the binding agent is selected from the group consisting of: a cellulose and a modified cellulose.

17. The method of claim 14, wherein a composition of the emulsion comprises approximately 3-5% of the binding agent, approximately 1-100% of the vegetable oil, and approximately 85-95% of the ice.

18. The method of claim 14, wherein the preparing of the binding agent emulsion using the device further comprises:
setting the device to a vacuum; and
chopping components in the device at a chopping speed between approximately 2000 rpm to approximately 6000 rpm to form the binding agent emulsion.

19. The method of claim 12, wherein the preparing the minced product comprises:
adding chilled ground jackfruit, a flavoring component, and a salt to the binding agent emulsion in the device;
mixing components in the device until a homogenous product is formed;
adding an oil to the device; and
mixing the components in the device until the minced product is formed.

20. The method of claim 19, wherein the chilled ground jackfruit is present in an amount of approximately 60-80%.

21. The method of claim 19, wherein the binding agent emulsion is present in an amount of approximately 25-35%.

22. The method of claim 19, wherein the flavoring component is present in an amount of approximately 0.1-1%.

23. The method of claim 19, wherein the salt is present in an amount of approximately 0.1-1%.

24. The method of claim 19,
wherein the oil comprises a vegetable oil,
wherein the vegetable oil is selected from the group consisting of: a canola oil, a soybean oil, a corn oil, and a grapeseed oil, and
wherein the vegetable oil is present in an amount of approximately 1-10%%.

25. The method of claim 19, further comprising:
transferring the minced product to a packaging line for packaging and freezing.
